(19) United States
(12) Patent Application Publication
(10) Pub. No.: US 2006/0220616 A1
(43) Pub. Date: Oct. 5, 2006

(54) Device for removing lead sulfide deposited on electrode surfaces of lead storage battery

(76) Inventor: Shigeo Okuno, Nagoya-shi (JP)

Correspondence Address: WENDEROTH, LIND & PONACK, L.L.P., 2033 K STREET N. W., SUITE 800, WASHINGTON, DC, 20006-1021, US

(21) Appl. No.: 10/553,837

(22) PCT Filed: May 11, 2004
(86) PCT No.: PCT/JP04/06251

§ 371 Date: Oct. 20, 2005

(30) Foreign Application Priority Data
May 12, 2003 (JP) 2003-171400

(51) Int. Cl. H02J 7/00

(52) U.S. Cl. 320/131

(57) ABSTRACT

A device for removing lead sulfate, wherein: using a positive voltage E (v) of a lead-acid battery as a reference, as shown in FIG. 1, spike-shaped voltage pulses (of duration of 1 μs or less) pointing in a negative direction from the positive voltage E (v) are continuously applied between a positive electrode and a negative electrode of the lead-acid battery, to thereby pulverize, without damage to the electrodes, non-conducting crystals—hereinafter referred to as lead sulfate (PbSO₄)—largely built up on the electrode surfaces of the lead-acid battery, gradually, starting from a point where the crystals on the projecting crystal surfaces are spaced apart from each other by the smallest distance between the positive and negative electrodes, thus returning the pulverized lead sulfate (PbSO₄) crystals to dilute sulfuric acid, followed by charging the battery to thereby dissociate the pulverized lead sulfate (PbSO₄) crystals into Pb⁺ and SO₄⁻ in the dilute sulfuric acid, which then return to the respective electrodes to thereby recondition the lead-acid battery. The device comprises: a reverse connection protection circuit; a voltage detection circuit; a reference-voltage generating circuit; a voltage comparator circuit; an operation/non-operation switching circuit; an oscillating circuit; an amplifier circuit; a spike-shaped voltage pulse generating circuit for generating spike-shaped voltage pulses of a short duration (Tb) of 1 μs or less; a wave shaping circuit; and an operation indicator which is operated only by pressing an operation check switch.

### TECHNICAL FIELD

The present invention relates to a device for removing lead sulfate deposited on electrodes of a lead-acid battery.

### BACKGROUND ART

With respect to a lead-acid battery, it has been known that, due to conditions during discharge and self-discharge, changes in ambient temperature when the battery is left unused, vibration, etc., lead sulfate (PbSO₄) deposits build up and cover surfaces of electrode plates, which leads to an increase in internal resistance to such a degree that the lead-acid battery is no longer operable.

In order to prevent the buildup of lead sulfate (PbSO₄) deposits, discharge conditions, temperature, vibration, etc. must be closely monitored. However, practically, in use of a lead-acid battery, it is nearly impossible to constantly monitor these conditions. Hence, there has been a need for a new method for removing lead sulfate (PbSO₄) deposits.

### BRIEF DESCRIPTION OF THE DRAWINGS

FIG. 1 shows a waveform at point A in a structural view of a circuit shown in FIG. 2.

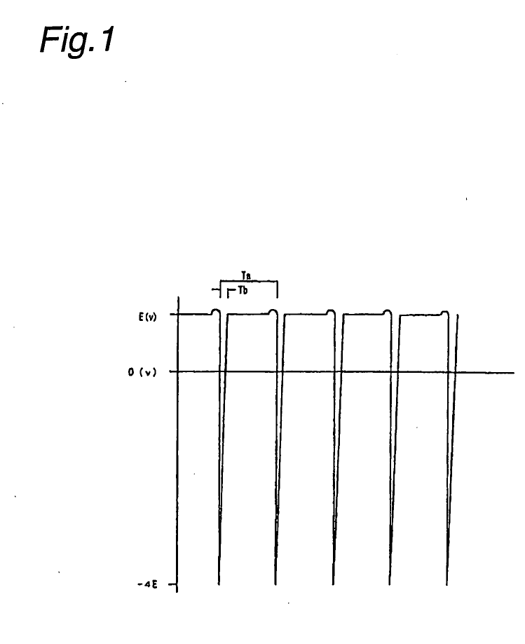

FIG. 2 shows a circuit structure of a device, according to the present invention, for removing lead sulfate (PbSO₄) deposited on electrodes of a lead-acid battery.

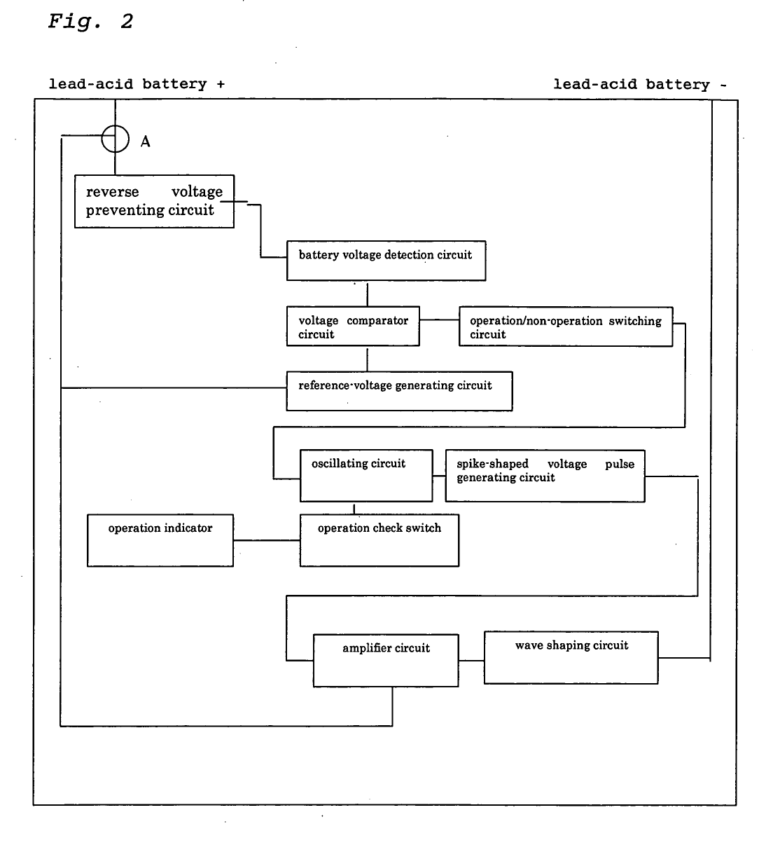

### DISCLOSURE OF THE INVENTION

### PROBLEMS TO BE SOLVED BY THE INVENTION

In the past, devices have been made which are designed to temporarily recover the performance of a lead-acid battery by giving electric shocks between lead sulfate (PbSO₄) deposits, which have been largely built up on surfaces of electrodes of a lead-acid battery, and the surfaces of the electrodes, thereby removing the lead sulfate (PbSO₄) deposits from the electrodes and dropping the removed lead sulfate (PbSO₄) deposits under the electrodes. In these devices, however, the recovery of the performance of the lead-acid battery is only temporary. The reason is as follows: A prompt recovery of the relative density of an electrolyte solution cannot be achieved by simply dropping the lead sulfate (PbSO₄) deposits under the electrodes after removing the deposits from the electrodes. To achieve a prompt recovery of the relative density of the electrolyte solution, dilute sulfuric acid must be added. However, after the addition, the lead sulfate (PbSO₄) deposits left under the electrodes are gradually dissolved back into the solution, which causes an abnormal increase in the relative density of the solution and subsequent damage to the surfaces of the electrodes. As a result, the entire electrodes are destroyed, shortening the lifetime of the lead-acid battery itself.

### MEANS TO SOLVE THE PROBLEMS

Instead of a method of simply dropping lead sulfate (PbSO₄) deposits largely built up on surfaces of electrodes of a lead-acid battery under the electrodes, we have invented a method for recovering the performance of a lead-acid battery, which is conducted in-the following manner. First, by continuously applying a current generated by a spike-shaped voltage pulse of duration (Tb) of 1 μs or less pointing in a negative direction from a positive voltage E (v) at a frequency of 1 kHz to 100 kHz, lead sulfate (PbSO₄) deposits are continuously destroyed without damage to the electrodes, due to a skin effect and a skin depth determined by the skin effect, gradually from portions closer to projecting crystal surfaces of the lead sulfate (PbSO₄) deposits. The destroyed lead sulfate (PbSO₄) deposits are returned, in the form of ultrafine lead sulfate particles, to dilute sulfuric acid. Thereafter, by charging the battery, the destroyed lead sulfate (PbSO₄) deposits are dissociated into Pb⁺ and SO₄⁻ in the dilute sulfuric acid solution, which subsequently return to the respective electrodes. In this method, because a current is not directly applied to the electrodes of the lead-acid battery, there is no damage to the electrodes. Further, the relative density of the lead-acid battery is recovered in proportion to an amount of time of the current application, to thereby recover the performance of the lead-acid battery.

### EFFECTS OF THE INVENTION

Using a device for removing lead sulfate (PbSO₄) deposited on electrodes of a lead-acid battery, a current generated by a spike-shaped voltage pulse of a short duration (Tb) of 1 μs or less pointing in a negative direction from a positive voltage E (v) was applied at a frequency of 1 kHz to 100 kHz between positive and negative electrodes of a lead-acid battery. As a result, crystal surface portions of largely built-up lead sulfate (PbSO₄) were destroyed due to intensive concentrations of charge on projecting portions of crystal surfaces, a skin effect, and a skin depth determined by the skin effect, and were gradually converted into sulfuric acid (H₂SO₄), lead (Pb), lead dioxide (PbO₂), and water (H₂O), to thereby recondition the lead-acid battery to its as-manufactured condition.

### BEST MODE FOR CARRYING OUT THE INVENTION

In order to convert lead sulfate (PbSO₄) largely built up on electrodes into sulfuric acid (H₂SO₄), lead (Pb), lead dioxide (PbO₂) and water (H₂O), we have invented a method of applying, through the electrodes, a current generated by a spike-shaped voltage pulse of duration (Tb) of 1 μs or less pointing in a negative direction from a positive voltage E (v) at a frequency of 1 kHz to 100 kHz. Due to a skin effect and a penetration depth (which is estimated to be 0.01 mm or less) which is determined by a skin depth associated with the skin effect, the current generated by the negative-pointing, spike-shaped voltage pulse of a short duration (Tb) of 1 μs or less acts to intensively destroy only very thin surface portions of lead sulfate crystals. Further, the destruction of the lead sulfate (PbSO₄) deposits built up between the positive and the negative electrodes of the lead-acid battery occurs gradually, starting from a point where the crystals are spaced apart from each other by the smallest distance between the electrodes. Therefore, without damage to the electrodes, lead sulfate (PbSO₄) crystals float, in the form of ultrafine lead sulfate (PbSO₄) particles, in dilute sulfuric acid. Thereafter, by charging the lead-acid battery, the lead sulfate (PbSO₄) crystals are dissociated into Pb⁺ and SO₄⁻ in the dilute sulfuric acid solution, which subsequently return to the respective electrodes, to thereby recover the initial relative density and recondition the lead-acid battery. The recovery time to restore the performance of the lead-acid battery varies, depending on a change in frequency of the applied current, which ranges from 1 kHz to 100 kHz.

### Embodiment

A current generated by a negative-pointing, spike-shaped voltage pulse of duration (Tb) of 1 μs or less is generated by a reverse voltage pulse generator, and is applied at a frequency of 1 kHz to 100 kHz to electrodes of a lead-acid battery. As a result, due to a skin effect and a skin depth determined by a pulse duration associated with the skin effect, lead sulfate (PbSO₄) deposits are destroyed, gradually from substantially projecting portions of lead sulfate (PbSO₄) crystal surfaces. Thereafter, by charging the battery, the destroyed lead sulfate (PbSO₄) crystals are converted into sulfuric acid (H₂SO₄), lead (Pb), lead dioxide (PbO₂) and water (H₂O). By repeating a process of applying a current generated by a spike-shaped voltage pulse of duration (Tb) of 1 μs or less pointing in a negative direction from a positive voltage E (v) and charging the battery, lead sulfate (PbSO₄) crystals deposited on the electrode surfaces of the lead-acid battery are destroyed, to thereby restore a porous structure of the electrodes and the performance of the lead-acid battery.

The duration of the spike is set at 1 μs, but can be set at any value less than 1 μs. However, from an engineering point of view, it is difficult to generate spike-shaped voltage pulses of a short duration (Tb) of a few nanoseconds at a reasonable cost. Therefore, the duration of the spike is set at 1 μs, which does not practically pose a problem.

The magnitude of a reverse voltage is set at a value approximately four times greater than the magnitude of power source voltage E (v), but can be set at any value greater than that. The reverse voltage should be determined according to the size of electrodes of a lead-acid battery.

The frequency of repetitive applications of the reverse voltage is set at 1 kHz to 100 kHz. However, an optimal frequency should be chosen according to the size of electrodes of a lead-acid battery, the conditions of lead sulfate (PbSO₄), and the length of recovery time.

1. A device for removing lead sulfate, wherein:
using a positive voltage E (v) of a lead-acid battery as a reference, spike-shaped voltage pulses pointing in a negative direction from the positive voltage E (v) are applied between a positive electrode and a negative electrode of the lead-acid battery, to thereby pulverize non-conducting crystals—hereinafter referred to as lead sulfate (PbSO₄)—largely built up on the electrode surfaces of the lead-acid battery, gradually, starting from a point where the crystals on the projecting crystal surfaces are spaced apart from each other by the smallest distance between the positive and negative electrodes, thus returning the pulverized lead sulfate (PbSO₄) crystals to dilute sulfuric acid, followed by charging the battery to thereby dissociate the pulverized lead sulfate (PbSO₄) crystals into Pb⁺ and SO₄⁻ in the dilute sulfuric acid, which return to the respective electrodes to thereby recondition the lead-acid battery.

2. A device for removing lead sulfate according to claim 1, wherein:
a very thin penetration depth due to a skin effect caused by applying, between the positive and negative electrodes of the lead-acid battery, a current generated by the spike-shaped voltage pulses of duration (Tb) of 1 μs or less pointing in the negative direction from the positive voltage E (v) enables only crystal surfaces of the lead sulfate to be pulverized, thereby reconditioning the lead-acid battery without damage to the electrode surfaces.

3. A device for removing lead sulfate according to claim 1, wherein:
a frequency of the spike-shaped voltage pulses pointing in the negative direction from the positive voltage E (v) is adjusted in a range of 1 kHz to 100 kHz according to conditions of the electrodes of the lead-acid battery, to thereby obtain an optimal value of frequency, which is applied between the positive and negative electrodes of the lead-acid battery, thereby reconditioning the lead-acid battery.

4. A device for removing sulfuric acid according to claim 1, wherein:
a low electric power is constantly consumed using the lead-acid battery as a power source, to thereby prevent deposition of lead sulfate on the electrodes of the lead-acid battery.

5. A device for removing lead sulfate according to claim 1, comprising: a reverse connection protection circuit; a voltage detection circuit; a reference-voltage generating circuit; a voltage comparator circuit; an operation/non-operation switching circuit; an oscillating circuit; an amplifier circuit; a spike-shaped voltage pulse generating circuit for generating spike-shaped voltage pulses of a short duration (Tb) of 1 μs or less; a wave shaping circuit; and an operation indicator which is operated only by pressing an operation check switch.
